(19) United States
(12) Patent Application Publication
(10) Pub. No.: US 2018/0372199 A1
(43) Pub. Date: Dec. 27, 2018

(54) MULTI-MODE CVP TRANSMISSION WITH GEARED LAUNCH AND REVERSE MODES

(71) Applicant: DANA LIMITED, MAUMEE, OH (US)

(72) Inventors: DAVID KIEKE, AUSTIN, TX (US); CHARLES B. LOHR, III, JONESTOWN, TX (US); GORDON MCINDOE, VOLENTE, TX (US)

(73) Assignee: DANA LIMITED, MAUMEE, OH (US)

(21) Appl. No.: 16/061,738

(22) PCT Filed: Dec. 16, 2016
(86) PCT No.: PCT/US2016/067137

§ 371 Date: Jun. 13, 2018

Related U.S. Application Data
(60) Provisional application No. 62/268,108, filed on Dec. 16, 2015.

(51) Int. Cl. F16H 37/08; F16H 15/28; F16H 47/04

(52) U.S. Cl. CPC F16H 37/086; F16H 15/28; F16H 2037/0866; F16H 2037/0886; F16H 2200/2023; F16H 47/04

(57) ABSTRACT

Devices and methods are provided herein for the transmission of power in motor vehicles. Power can be transmitted in a smoother and more efficient manner by splitting torque into two or more torque paths. A continuously variable transmission is provided with a ball variator assembly, a dual pinion planetary gearset coupled thereto and an arrangement of rotatable shafts with multiple gears and clutches that extend the ratio range of the variator. In some embodiments, a launch gear CVP bypass enables is provided.

### RELATED APPLICATION

The present application claims priority to and the benefit from Provisional U.S. Patent Application Ser. No. 62/268,108 filed on Dec. 16, 2015. The convent of the above-noted patent application is hereby expressly incorporated by reference into the detailed description of the present application.

### BACKGROUND

A driveline including a continuously variable transmission allows an operator or a control system to vary a drive ratio in a stepless manner, permitting a power source to operate at its most advantageous rotational speed.

### SUMMARY

Provided herein is a continuously variable transmission including: a first rotatable shaft operably coupleable to a source of rotational power; a second rotatable shaft aligned substantially coaxial to the first rotatable shaft, the first rotatable shaft and second rotatable shaft forming a main axis of the transmission; a variator assembly having a first traction ring assembly and a second traction ring assembly in contact with a plurality of traction planets, each traction planet having a tiltable axis of rotation; wherein the variator assembly is coaxial with the main axis; wherein the first traction ring assembly is operably coupled to the first rotatable shaft; a planetary gearset having a sun gear, a first set of planet gears, a second set of planet gears, a planet carrier, a first ring gear, and a second ring gear; wherein the sun gear is coupled to the second traction ring, the sun gear is coupled to the first set of planet gears, the first set of planet gears is coupled to the second set of planet gears, the first set of planet gears and the second set of planet gears are coupled to the planet carrier, the first ring gear is coupled to the first set of planet gears, and the second ring gear is coupled to the second set of planet gears; a first clutch operably coupled to the first rotatable shaft and the second rotatable shaft; a second clutch operably coupled to the planet carrier, the second clutch operably coupled to the first rotatable shaft; a third clutch operably coupled to the first ring gear, the third clutch operably coupled to the second rotatable shaft; a fourth clutch operably coupled to the second ring gear, the fourth clutch operably coupled to the second rotatable shaft.

Provided herein is a continuously variable transmission including: a torque converter including a turbine, a pump, and a stator; a first rotatable shaft aligned coaxially with the torque converter, the first rotatable shaft forming a main axis of the transmission; a second rotatable shaft aligned coaxially with the first rotatable shaft, the second rotatable shaft coupled to the turbine; a direct clutch coupled to the first rotatable shaft and a rotational source of power; a variator assembly having a first traction ring assembly and a second traction ring assembly in contact with a plurality of traction planets, each traction planet having a tiltable axis of rotation; wherein the variator assembly is coaxial with the main axis; wherein the second traction ring assembly is operably coupled to the first rotatable shaft; a planetary gearset having a ring gear, a carrier supporting a plurality of pinion gears, and a sun gear; a one-way device operably coupled to the second rotatable shaft; wherein the sun gear is coupled to the one-way device, and the carrier is operably coupled to the first traction ring assembly; a first synchronizer assembly coupled to the carrier; and a second synchronizer assembly coupled to the ring gear.

Provided herein is a continuously variable transmission including: a torque converter including a turbine, a pump, and a stator; a first rotatable shaft aligned coaxially with the torque converter, the first rotatable shaft forming a main axis of the transmission; a second rotatable shaft aligned coaxially with the first rotatable shaft, the second rotatable shaft coupled to the turbine; a direct clutch coupled to the first rotatable shaft and a rotational source of power; a variator assembly having a first traction ring assembly and a second traction ring assembly in contact with a plurality of traction planets, each traction planet having a tiltable axis of rotation; wherein the variator assembly is coaxial with the main axis; wherein the second traction ring assembly is operably coupled to the first rotatable shaft; a planetary gearset having a ring gear, a carrier supporting a first plurality of pinion gears and a second plurality of pinion gears, and a sun gear; a one-way device operably coupled to the carrier and the turbine; wherein the sun gear is operably coupled to the first traction ring assembly; a first, clutch adapted to selectively couple the carrier to the sun gear; and a second clutch adapted to selectively couple the ring gear to a grounded member.

Provided herein is a continuously variable transmission including: a torque converter including a turbine, a pump, and a stator; a first rotatable shaft aligned coaxially with the torque converter, the first rotatable shaft forming a main axis of the transmission; a second rotatable shaft aligned coaxially with the first rotatable shaft, the second rotatable shaft coupled to the turbine; a direct clutch coupled to the first rotatable shaft and a rotational source of power; a variator assembly having a first traction ring assembly and a second traction ring assembly in contact with a plurality of traction planets, each traction planet having a tiltable axis of rotation; wherein the variator assembly is coaxial with the main axis; a planetary gearset having a ring gear, a carrier supporting a first plurality of pinion gears and a second plurality of pinion gears, and a sun gear; wherein the second traction ring assembly is operably coupled to the sun gear; a one-way device operably coupled to the carrier and the turbine; wherein the first rotatable shaft is operably coupled to the first traction ring assembly; a first clutch adapted to selectively couple the carrier to the sun gear; and a second clutch adapted to selectively couple the ring gear to a grounded member.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the embodiments are utilized, and the accompanying drawings of which:

FIG. 1 is a side sectional view of a ball-type variator.

FIG. 2 is a plan view of a carrier member that can be used in the variator of FIG. 1.

FIG. 3 is an illustrative view of different tilt positions of the ball-type variator of FIG. 1.

FIG. 4 is a schematic diagram of a three-mode powersplit continuously variable transmission.

FIG. 5 is a table depicting a shift schedule for operating the transmission of FIG. 4

FIG. 6 is a block diagram of a continuously variable transmission equipped with a launch bypass branch.

FIG. 7 is a block diagram of a continuously variable transmission equipped with an overdrive bypass branch.

FIG. 8 is a block diagram of a continuously variable transmission equipped with a launch bypass branch and an overdrive bypass branch.

FIG. 9 is a schematic diagram of a powersplit variator.

FIG. 10 is a chart depicting operating modes of a continuously variable transmission equipped with a launch bypass branch and an overdrive bypass branch.

FIG. 11 is a schematic diagram of a continuously variable transmission having a bypass branch.

FIG. 12 is a schematic diagram of another continuously variable transmission having a bypass branch.

FIG. 13 is a schematic diagram of yet another continuously variable transmission having a bypass branch.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, embodiments can include several novel features, no single one of which is solely responsible for its desirable attributes or which is essential to practicing the preferred embodiments described.

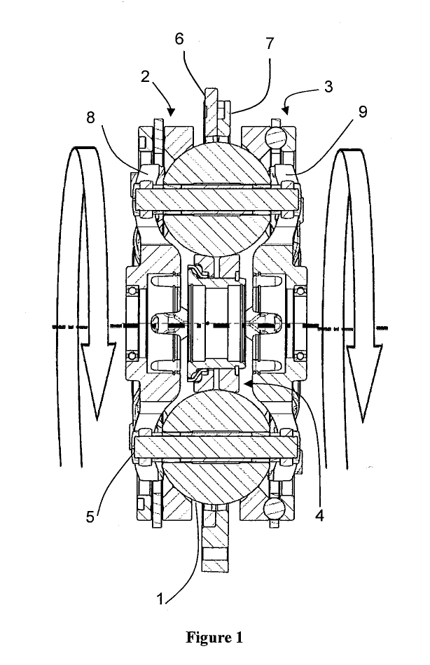

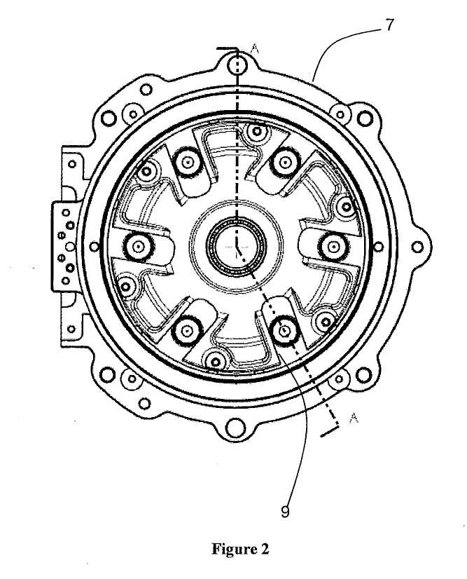

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input 2 and output 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 can rotate with respect to the second carrier member 7, and vice versa. In some embodiments, the first carrier member 6 can be substantially fixed from rotation while the second carrier member 7 is configured to rotate with respect to the first carrier member, and vice versa. In one embodiment, the first carrier member 6 can be provided with a number of radial guide slots 8. The second carrier member 7 can be provided with a number of radially offset guide slots 9, as illustrated in FIG. 2. The radial guide slots 8 and the radially offset guide slots 9 are adapted to guide the tiltable axles 5. The axles 5 can be adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

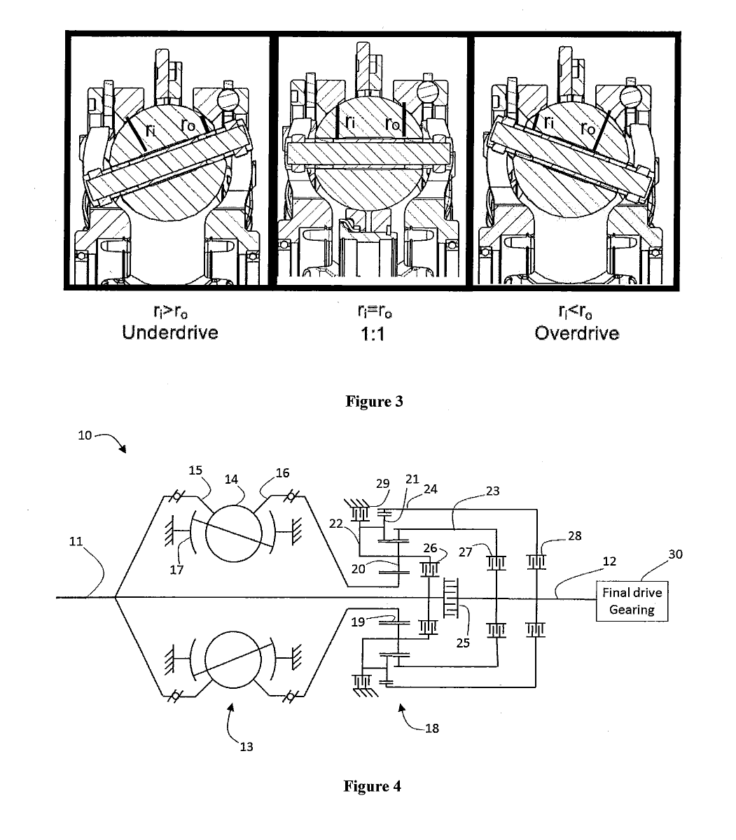

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio can be changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling can take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The term “traction coefficient (μ) represents the ratio of transmitted force at the interfaces of the contacting components to the normal force acting between the same components. The term traction coefficient is sometimes used to indicate the maximum available traction coefficient at the current conditions for the fluid in use. The combined term “applied traction coefficient” also indicates the ratio of the current observed or calculated transmitted force at the contacting components to the normal force acting between the contacting components. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here can operate in both tractive and frictional applications. For example, in the embodiment where a CVT is used for a bicycle application, the CVT can operate at times as a friction drive and at other times as a traction drive, depending on the torque and speed conditions present during operation.

Referring now to FIG. 4, in one embodiment, a continuously variable transmission (CVT) 10 is provided with a first rotatable shaft 11 and a second rotatable shaft 12. The first rotatable shaft 11 and the second rotatable shaft 12 are aligned substantially coaxially and form a main axis of the transmission, sometimes referred to herein as a longitudinal axis of the transmission. In one embodiment, the first rotatable shaft 11 is adapted to couple to a source of rotational power. The CVT 10 includes a variator assembly 13 arranged coaxially with the main axis. The variator assembly 13 includes a number of traction planets 14 in contact with a first traction ring assembly 15 and a second traction ring assembly 16. The traction planets 14 are supported in a variator carrier assembly 17. It should be appreciated that the variator assembly 13 can be configured in a similar manner to the CVT described in FIGS. 1-3. In one embodiment, the CVT 10 is provided with a planetary gear set 18. The planetary gear set 18 is a dual pinion style gear set. The planetary gear set 18 includes a sun gear 19 coupled to a first set of planet gears 20. The first set of planet gears 20 couple to a second set of planet gears 21. The first set of planet gears 20 and the second set of planet gears 21 are supported in a planet carrier 22. The first set of planet gears 20 are coupled to a first ring gear 23. The second set of planet gears 21 are coupled to a second ring gear 24. In one embodiment, the sun gear 19 is operably coupled to the second traction ring assembly 16.

In one embodiment, the CVT 10 includes a first clutch 25 operably coupled to the first rotatable shaft 11 and the second rotatable shaft 12. The first clutch 25 is configured to selectively engage and disengage the first rotatable shaft 11 with the second rotatable shaft 12. Engagement of the first clutch 25 corresponds to an engagement of the first rotatable shaft 11 and the second rotatable shaft 12. In one embodiment, the CVT 10 includes a second clutch 26 operably coupled to the first rotatable shaft 11. The second clutch 26 is configured to selectively engage the planet carrier 22. The CVT 10 includes a third clutch 27 operably coupled to the second rotatable shaft 12. The third clutch 27 is configured to selectively engage the first ring gear 23. The CVT 10 includes a fourth clutch 28 operably coupled to the second rotatable shaft 12. The fourth clutch 28 is configured to selectively engage the second ring gear 24. In one embodiment, the CVT 10 includes a reverse clutch 29 operably coupled to a grounded member such as a housing (not shown). The reverse clutch 19 is configured to selectively couple to the planet carrier 22. In some embodiments, the CVT 10 includes a final drive gear set 30 operably coupled to the second rotatable shaft 12. The final drive gear set 30 optionally includes gear sets, shafts, clutches, or other power transmission components. It should be appreciated that the first clutch 25, the second clutch 26, the third clutch 27, the fourth clutch 28, and the reverse clutch 29 are typical selectable torque transmitting devices such as wet clutches, dry clutches, synchro clutches, cone clutches, dog clutches, among others.

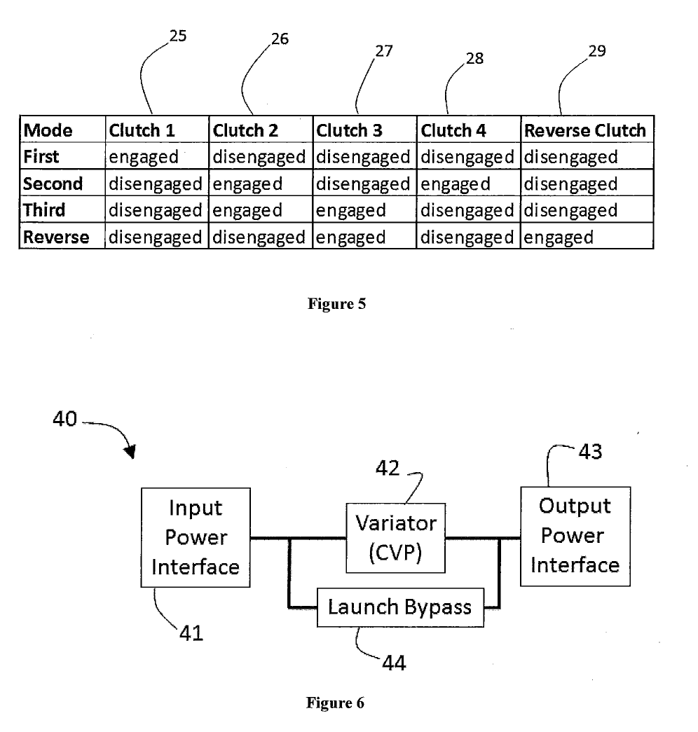

Referring now to FIG. 5, during operation of the CVT 10, engagement and disengagement of the first clutch 25, the second clutch 26, the third clutch 27, the fourth clutch 28, and the reverse clutch 29 can be manipulated by a transmission control system (not shown) to achieve a number of modes of operation. For example, a first mode of operation corresponds to the engagement of the first clutch 25 to couple the first rotatable shaft 11 to the second rotatable shaft 12. During the first mode of operation, the second clutch 26, the third clutch 27, the fourth clutch 28, and the reverse clutch 29 are disengaged. The first mode of operation is sometimes referred to as a launch mode or a direct mode. During the first mode of operation, an input power received on the first rotatable shaft 11 is transmitted directly to the second rotatable shaft 12. Other transmission components coupled to the first rotatable shaft 11, such as the first traction ring assembly 15, will rotate with the application of the input power and spin freely without the transfer of torque.

Still referring to FIG. 5, a second mode of operation corresponds to the engagement of the second clutch 26 and the fourth clutch 28, and the disengagement of the first clutch 25, the third clutch 27, and the reverse clutch 29. During the second mode of operation, an input power is split between two paths. A first path of power transmission is through the variator assembly 13. A second path of power transmission is through the planetary gear set 18. The second mode of operation generally achieves a higher output speed range than the first mode of operation.

Still referring to FIG. 5, a third mode of operation corresponds to the engagement of the second clutch 26 and the third clutch 27, and the disengagement of the first clutch 25, the fourth clutch 28, and the reverse clutch 29. During the third mode of operation, an input power is split between two paths. The first path of power transmission is through the variator assembly 13. The second path of power transmission is through the planetary gear set 18. The third mode of operation generally achieves a higher output speed range than the second mode of operation or the first mode of operation.

Still referring to FIG. 5, a reverse mode of operation corresponds to the engagement of the reverse clutch 29 and the third clutch 27, and the disengagement of the first clutch 25, the second clutch 26, and the fourth clutch 28. The reverse mode of operation generally achieves opposite direction of rotation of the second rotatable shaft 12.

Turning now to FIG. 6, in one embodiment, a continuously variable transmission (CVT) 40 includes an input power interface 41 operably coupled to a variator 42. The CVT 40 includes an output power interface 43 operably coupled the variator 42. In one embodiment, the CVT 40 includes a launch bypass branch 44 operably coupled to the input power interface 41 and the output power interface 43. The launch bypass branch 44 includes gearing, selectable torque transmitting devices, such as clutches, and associated controls to enable transmission of power from the input power interface 41 to the output power interface 43. In one embodiment, the launch bypass branch 44 is configured to transmit substantially all of the power delivered from the input power interface 41 to the output power interface 43 during a launch condition of a vehicle equipped with the CVT 40. It should be understood that a launch condition corresponds to an operating condition when the vehicle accelerates from a stop in a forward direction. In some embodiments, the launch bypass branch 44 is further provided with a reverse gear. A reverse condition corresponds to an operating condition when the vehicle accelerates from a stop in a reverse direction. In one embodiment, the input power interface 41 is configured for receiving power from a prime mover such as an internal combustion engine, an electric motor, among others. In one embodiment, the input power interface 41 includes gearing or coupling structure suitable for providing a distributed power transfer and distribution functionality. In some embodiments, the input power interface 41 is a torque converter assembly, a hydraulic clutch coupling, a manually actuated clutch assembly, a computer-controlled clutch assembly, a magnetorheological clutch coupled, and the like. In one embodiment, the output interface 43 includes gearing or coupling devices configured to transmit a rotational power to other drivetrain components. In one embodiment, the output interface 43 is configured for combining power (that is, torque applied at a given rotational speed) from the variator 42 and the launch bypass branch 44.

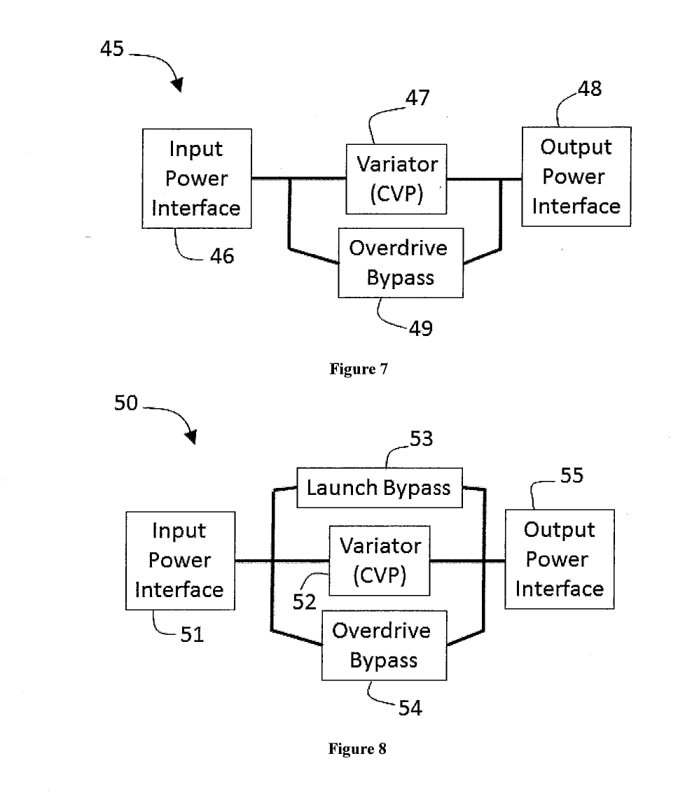

Referring now to FIG. 7, in one embodiment, a continuously variable transmission (CVT) 45 includes an input power interface 46 operably coupled to a variator 47. The CVT 45 includes an output power interface 48 operably coupled the variator 47. In one embodiment, the CVT 45 includes an overdrive bypass branch 49 operably coupled to the input power interface 46 and the output power interface 48. The overdrive bypass branch 49 includes gearing, selectable torque transmitting devices, such as clutches, and associated controls to enable transmission of power from the input power interface 46 to the output power interface 48. In one embodiment, the overdrive bypass branch 49 is configured to transmit substantially all of the power delivered from the input power interface 46 to the output power interface 47 during an overdrive condition of a vehicle equipped with the CVT 45. It should be understood that an overdrive condition corresponds to an operating condition when the vehicle is cruising at speeds above a pre-determine speed threshold associated with common highway driving conditions. In one embodiment, the input power interface 46 is configured for receiving power from a prime mover such as an internal combustion engine, an electric motor, among others. In one embodiment, the input power interface 46 includes gearing or coupling structures suitable for providing a distributed power transfer and distribution functionality. In some embodiments, the input power interface 46 is a torque converter assembly, a hydraulic clutch coupling, a manually actuated clutch assembly, a computer-controlled clutch assembly, a magnetorheological clutch coupled, and the like. In one embodiment, the output interface 48 includes gearing or coupling devices configured to transmit a rotational power to other drivetrain components equipped on the vehicle. In one embodiment, the output interface 48 is configured for combining power (that is, torque applied at a given rotational speed) from the variator 47 and the overdrive bypass branch 49.

Referring now to FIG. 8, in one embodiment, a continuously variable transmission (CVT) 50 includes an input power interface 51 operably coupled to a variator 52. The CVT 50 is provided with a launch bypass branch 53 operably coupled to the input power interface 51. The CVT 50 is provided with an overdrive bypass branch 54 operably coupled to the input power interface 51. In one embodiment, the CVT 50 is provided with an output power interface 55. The launch bypass branch 53 includes gearing, selectable torque transmitting devices, such as clutches, and associated controls to enable transmission of power from the input power interface 51 to the output power interface 55. In one embodiment, the launch bypass branch 53 is configured to transmit substantially all of the power delivered from the input power interface 51 to the output power interface 55 during a launch condition of a vehicle equipped with the CVT 50. It should be understood that a launch condition corresponds to an operating condition when the vehicle accelerates from a stop in a forward direction. In some embodiments, the launch bypass branch 53 is further provided with a reverse gear. A reverse condition corresponds to an operating condition when the vehicle accelerates from a stop in a reverse direction. In one embodiment, the input power interface 51 is configured for receiving power from a prime mover such as an internal combustion engine, an electric motor, among others. In one embodiment, the input power interface 51 includes gearing or coupling structure suitable for providing a distributed power transfer and distribution functionality. In some embodiments, the input power interface 51 is a torque converter assembly, a hydraulic clutch coupling, a manually actuated clutch assembly, a computer-controlled clutch assembly, a magnetorheological clutch coupled, and the like. In one embodiment, the output interface 55 includes gearing or coupling devices configured to transmit a rotational power to other drivetrain components. In one embodiment, the output interface 55 is configured for combining power (that is, torque applied at a given rotational speed) from the variator 52 and the launch bypass branch 53. In one embodiment, the overdrive bypass branch 54 is configured to transmit substantially all of the power delivered from the input power interface 51 to the output power interface 55 during an overdrive condition of a vehicle equipped with the CVT 50. It should be understood that an overdrive condition corresponds to an operating condition when the vehicle is cruising at speeds above a pre-determine speed threshold associated with common highway driving conditions. It should be understood that the CVT 50 is configurable to include multiple clutches and gearing to facilitate a variety of operating modes of the vehicle. For example, the CVT 50 optionally includes a number of mode selector clutches configured to provide a number of output speed ranges. In one embodiment, the CVT 50 is configured to include a main shaft and a parallel shaft. In some embodiments, the launch bypass branch 53 is operably coupled to the parallel shaft. In some embodiments, the overdrive bypass branch 54 is Operably coupled to the parallel shaft. In other embodiments, the CVT 50 is provided with a number of one-way clutches to facilitate the transition between operating modes of the CVT 50.

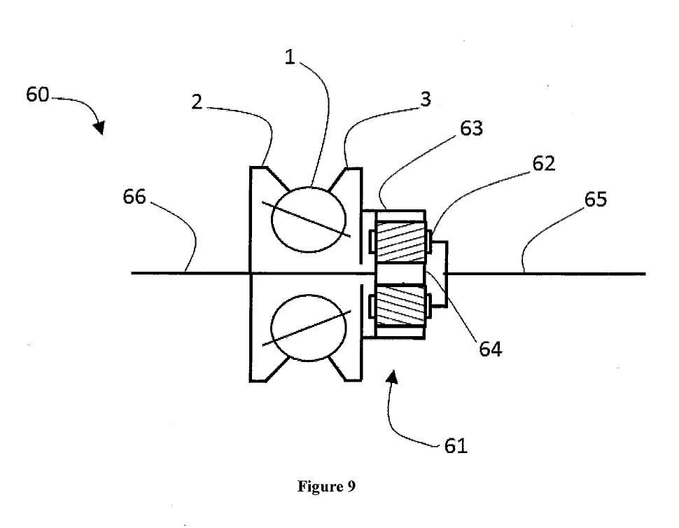

Turning now to FIG. 9 and still referring to FIG. 1, in one embodiment, a powersplit variator 60 includes the balls 1, the first traction ring assembly 2, and the second traction ring assembly 3 operably coupled to a planetary gear set 61. The planetary gear set includes a planet carrier 62 coupled to a ring gear 63 and coupled to a sun gear 64. In one embodiment, a first shaft 65 is coupled to the planet carrier 62. The first shaft 65 is adapted to transfer rotational power. In one embodiment, the first shaft 65 is operably coupled to a source of rotational power, such as an internal combustion engine, an electric motor, or other input power coupling device, for example, a torque converter. Configurations of continuously variable transmission having the first shaft 65 coupled to a source of rotational power is sometimes referred to as “input coupled power split”. In one embodiment, the first traction ring assembly 2 is coupled to a second shaft 66 In one embodiment, the second traction ring assembly 3 is coupled to the ring gear 63. The first rotatable shaft 65 and the second rotatable shaft 66 are coaxial. The first rotatable shaft 65 and the second rotatable shaft 66 form a main axis, or longitudinal axis, of the powersplit variator 60. In some embodiments, the second shaft 66 is operably coupled to a power output interface, such as a gear box or differential. In other embodiments, the second shaft 66 is coupled to a source of rotational power and the first shaft 65 is coupled to a power output interface, such as a gear box or differential. Configurations of continuously variable transmissions having the first shaft 65 coupled to a power output interface are sometimes referred to as “output coupled power split”. It should be noted that various embodiments of transmission configurations presented herein include clutches, shafts, gear sets, and other power transmission couplings adapted to couple to the powersplit variator 60. For description purposes, embodiments disclosed herein include the powersplit variator 60. It should be appreciated, that some embodiments can include other configurations of the powersplit variator 60 or the variator depicted in FIG. 1.

In some embodiments, the variator 42 is the powersplit variator 60. In one embodiment, the powersplit variator 60 is configured as an input coupled power split in the CVT 40. In one embodiment, the powersplit variator 60 is configured as an output coupled power split in the CVT 40. In some embodiments, the variator 47 is the powersplit variator 60. In one embodiment, the powersplit variator 60 is configured as an input coupled power split in the CVT 45. In one embodiment, the powersplit variator 60 is configured as an output coupled power split in the CVT 45. In some embodiments, the variator 52 is the powersplit variator 60. In one embodiment, the powersplit variator 60 is configured as an input coupled power split in the CVT 50. In one embodiment, the powersplit variator 60 is configured as an output coupled power split in the CVT 50.

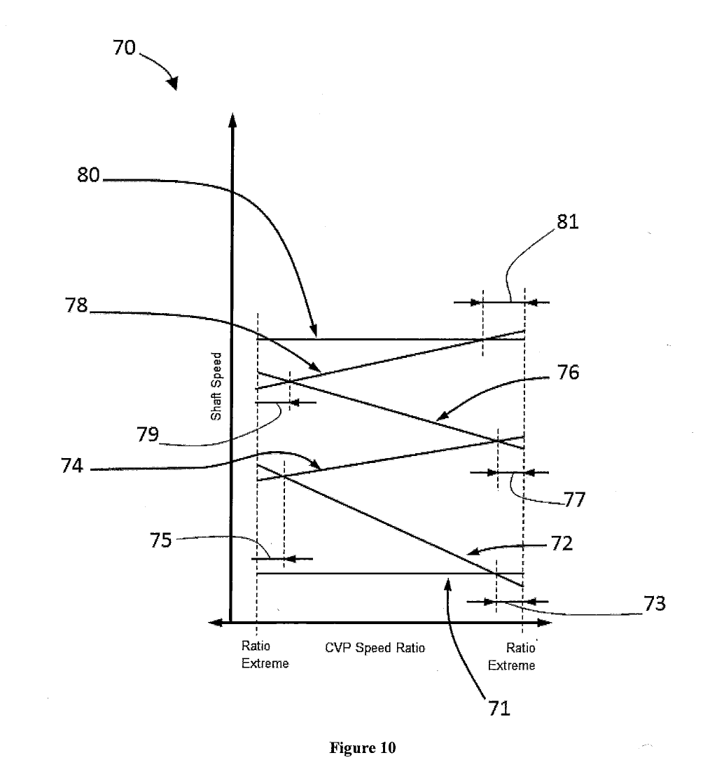

Passing now to FIG. 10, for the purposes of description and not limitation, certain modes of operation for the continuously variable transmission (CVT) 50, for example, are described herein with reference to the chart 70 depicted in FIG. 10. It should be appreciated that references to a parallel shaft refer to the corresponding shaft of the launch bypass branch 53 and the overdrive bypass 54, which are typically parallel to the axis of the variator (CVP) 52. The CVT 50 is optionally configured with a number of clutches and fixed ratio gear set to enable multi-mode operation. The specific arrangement of said clutches and fixed ratio gear sets are within a designers choice. The chart 70 depicts modes of operation in terms of variator (CVP) speed ratio (x-axis) and shaft speed (y-axis). For a forward launch condition 71, a forward launch clutch equipped in the launch bypass branch 53 is engaged. A Mode 1 selector clutch (not shown) can be engaged if CVP SR at extreme ratio. A Mode 1 gear 72 is slower than a parallel shaft speed of the launch bypass branch 53. A mode shift overlap 73 corresponds to a condition when a forward launch clutch (not shown) of the launch bypass branch 53 is engaged and is driving the parallel shaft of the launch bypass branch 53 while the Mode 1 selector clutch is engaged. In some embodiments, a one-way clutch is provided, and facilitates the parallel shaft spinning freely within Mode 1 gear 72. The Mode 1 gear 72 corresponds to a driven parallel shaft. To transition from the Mode 1 gear 72 to a Mode 2 gear 74, depicted in a mode-1-to-mode-2 overlap 75 on the chart 70, the forward selector clutch can remain engaged. The forward launch gear speed 71 is slower than parallel shaft speed. The one-way clutch is provided to allow the parallel shaft to spin free within forward gear. The Mode 1 gear 72 is driving the parallel shaft while a Mode 2 selector clutch (not shown) engages. The Mode 2 gear 74 is slower than parallel shaft speed. A one-way clutch can be provided to allow the parallel shaft to spin free within the Mode 2 gear 74. In the Mode 2 gear 74, the parallel shaft is driven, the forward selector clutch can remain engaged, the forward launch gear speed 71 is slower than parallel shaft speed, a one-way clutch allows the parallel shaft to spin free within forward gear, the Mode 1 selector clutch can remain engaged, the Mode 1 gear 72 is slower than parallel shaft speed. A transition from the mode 2 gear 74 to a Mode 3 gear 76 occurs in a mode-2-to-mode-3 overlap 77 on the chart 70. Operation in the mode 3 gear 76 corresponds to the parallel shaft being driven, the forward selector clutch remaining engaged, the forward launch gear speed operating slower than parallel shaft speed, a one-way clutch allowing the parallel shaft to spin free within FWD gear, the Mode 2 selector clutch remaining engaged, the Mode 2 gear 74 operating slower than parallel shaft speed, a one-way clutch allowing the parallel shaft to spin free within the Mode 2 gear 74. A transition from the Mode 3 gear 76 to a Mode 4 gear 78 occurs in a mode-3-to-mode-4 overlap 79 on the chart 70. In the Mode 4 gear 78, the forward selector clutch remains engaged, the forward launch gear speed is slower than parallel shaft speed, a one-way clutch allows the parallel shaft to spin free within FWD gear, the Mode 3 selector clutch remains engaged, the Mode 3 gear 76 is slower than parallel shaft speed, a one-way clutch allows the parallel shaft to spin free within the Mode 3 gear 76. A transition from the Mode 4 gear 78 to a top gear 80 occurs at a mode-4-to-top-gear overlap 81 in the chart 70. In the top gear 80, the parallel shaft is driven, the forward selector clutch remains engaged, the forward launch gear speed is slower than parallel shaft speed, a one-way clutch allows the parallel shaft to spin free within FWD gear, Mode 3 selector clutch remains engaged, the Mode 3 gear speed is slower than parallel shaft speed, a one-way clutch allows the parallel shaft to spin free within the Mode 3 gear 76, the Mode 4 selector clutch remains engaged, the Mode 4 gear 78 is slower than parallel shaft speed, a one-way clutch allows the parallel shaft to spin free within the Mode 4 gear 78.

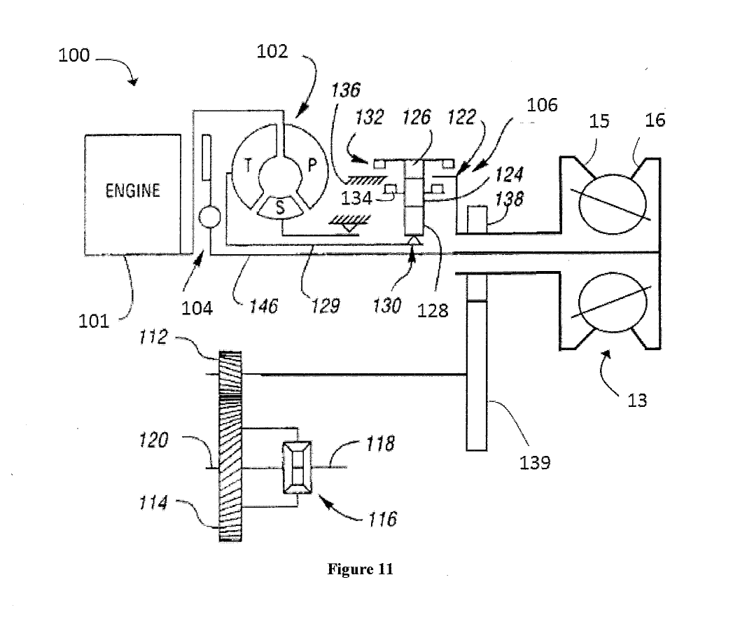

Referring now to FIG. 11, in some embodiments, a continuously variable transmission (CVT) 100 includes an engine 101, a torque converter 102, a direct clutch 104, a planetary gear set 106, and the CVP 13 having the first traction ring assembly 15 and the second traction ring assembly 16. The direct clutch 104 is coupled to an input shaft 146 configured to transmit rotational power to the second traction ring assembly 16. In some embodiments, a shaft 129 is coupled to a turbine (labeled “T” in FIG. 11) of the torque converter 102. In some embodiments, the torque converter 102 includes the turbine T, a pump “P”, and a stator “S” that is a grounded member. The shaft 129 is configured to transmit rotational power to a one-way device 130. The one-way device 130 is configured to transmit rotational power to the planetary gear set 106. In some embodiments, the planetary gear set 106 includes a ring gear 126, a carrier 122 supporting a number of pinion gears 124, and a sun gear 128. The one-way device 130 is operably coupled to the sun gear 128. In some embodiments, the one-way device 130 is a typical mechanical one-way clutch. The ring gear 126 is controlled by a first synchronizer assembly 132. The carrier 122 is controlled by a second synchronizer assembly 134. The first synchronizer assembly 132 permits the ring gear 126 to be connected to a housing 136 or to an output gear 138. The second synchronizer assembly 134 permits the carrier 122 to be connected to a housing 136 or to an output gear 138. The output gear 138 is operably coupled to the first traction ring assembly 15. The output gear 138 is coupled to a transfer gear 139 configured to transmit a rotational power to a final gear drive 116. In some embodiments, the final gear drive 116 includes a gear 112 driving a gear 114. In some embodiments, the gear 114 is configured to drive a first output shaft 118 and a second output shaft 120. The second synchronizer assembly 134 permits the carrier 122 to be connected to the housing 136 or to the output gear 138.

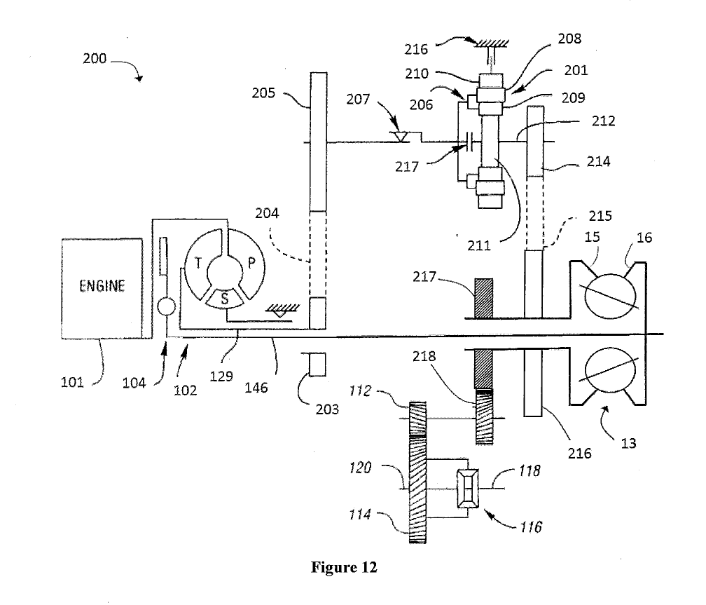

Passing now to FIG. 12, a continuously variable transmission 200 includes a number of similar components to the CVT 100. For conciseness, only the differences between the CVT 200 and the CVT 100 will be discussed. In some embodiments, the CVT 200 includes a first sprocket 203 operably coupled to the shaft 129. The first sprocket 203 is coupled to a chain 204 engaged with a second sprocket 205. The second sprocket 205 is configured to couple through a one-way clutch 207 to a planetary gear set 201. In some embodiments, the planetary gear set 201 includes a carrier 206 supporting a first array of pinion gears 208 meshing with a second array of pinion gears 209. The planetary gear set 201 includes a sun gear 211 and a ring gear 210. In some embodiments, a first clutch 217 is arranged to selectively couple the carrier 206 and the sun gear 211. A second clutch 216 is configured to selectively couple the ring gear 210 to the housing (grounded member). The sun gear 211 is coupled to a shaft 212. The shaft 212 is drivingly engaged to a third sprocket 214. The third sprocket 214 is coupled by a chain 215 to a fourth sprocket 216. The fourth sprocket 216 is operably coupled to the first traction ring assembly 15. The fourth sprocket 216 is configured to drive a first transfer gear 217. The first transfer gear 217 is coupled to a second transfer gear 218. The second transfer gear 218 is configured to transmit rotational power to the final drive gear 116.

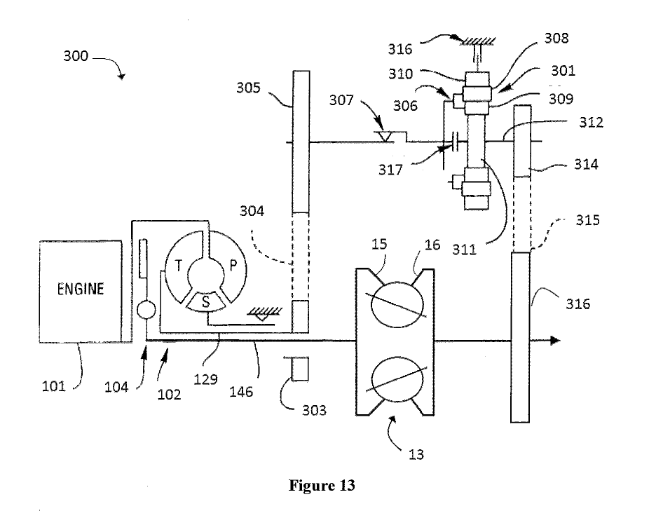

Passing now to FIG. 13, in some embodiments, a continuously variable transmission (CVT) 300 is similar to the CVT 200. For conciseness, only the differences between the CVT 200 and the CVT 300 will be described. In some embodiments, the input shaft 146 is operably coupled to the first traction ring assembly 15. In some embodiments, the CVT 300 includes a first sprocket 303 operably coupled to the shaft 129. The first sprocket 303 is coupled to a chain 304 engaged with a second sprocket 305. The second sprocket 305 is configured to couple through a one-way clutch 307 to a planetary gear set 301. It should be noted that the CVT 300 is optionally configured with fixed gear set in place of sprocket and chains. In some embodiments, the planetary gear set 301 includes a carrier 306 supporting a first array of pinion gears 308 meshing with a second array of pinion gears 309. The planetary gear set 301 includes a sun gear 311 and a ring gear 310. In some embodiments, a first clutch 317 is arranged to selectively couple the carrier 306 and the sun gear 311. A second clutch 316 is configured to selectively couple the ring gear 310 to the housing (grounded member). The sun gear 311 is coupled to a shaft 312. The shaft 312 is drivingly engaged to a third sprocket 314. The third sprocket 314 is coupled by a chain 315 to a fourth sprocket 316. The fourth sprocket 316 is operably coupled to the second traction ring assembly 16. The fourth sprocket 316 is configured to transmit rotational power out of the CVT 300.

It should be noted that the description above has provided dimensions for certain components or subassemblies. The mentioned dimensions, or ranges of dimensions, are provided in order to comply as best as possible with certain legal requirements, such as best mode. However, the scope of the embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the preferred embodiments. It is intended that the following claims define the scope of the preferred embodiments and that methods and structures within the scope of these claims and their equivalents be covered thereby.

What is claimed is:

1. A continuously variable transmission comprising:
a first rotatable shaft operably coupleable to a source of rotational power;
a second rotatable shaft aligned substantially coaxial to the first rotatable shaft, the first rotatable shaft and second rotatable shaft forming a main axis of the transmission;
a variator assembly having a first traction ring assembly and a second traction ring assembly in contact with a plurality of traction planets, each traction planet having a tiltable axis of rotation;
wherein the variator assembly is coaxial with the main axis;
wherein the first traction ring assembly is operably coupled to the first rotatable shaft;
a planetary gearset having a sun gear, a first set of planet gears, a second set of planet gears, a planet carrier, a first ring gear, and a second ring gear;
wherein the sun gear is coupled to the second traction ring, the sun gear is coupled to the first set of planet gears, the first set of planet gears is coupled to the second set of planet gears, the first set of planet gears and the second set of planet gears are coupled to the planet carrier, the first ring gear is coupled to the first set of planet gears, and the second ring gear is coupled to the second set of planet gears;
a first clutch operably coupled to the first rotatable shaft and the second rotatable shaft;
a second clutch operably coupled to the planet carrier, the second clutch operably coupled to the first rotatable shaft;
a third clutch operably coupled to the first ring gear, the third clutch operably coupled to the second rotatable shaft;
a fourth clutch operably coupled to the second ring gear, the fourth clutch operably coupled to the second rotatable shaft.

2. The continuously variable transmission of claim 1, further comprising a final drive gear set operably coupled to the second rotatable shaft.

3. The continuously variable transmission of claim 1, wherein engagement of the first clutch, disengagement of the second clutch, disengagement of the third clutch, and disengagement of the fourth clutch, corresponds to a first mode of operation.

4. The continuously variable transmission of claim 3, wherein the first mode of operation corresponds to an operating condition whereby the variator assembly passes substantially zero torque.

5. The continuously variable transmission of claim 1, further comprising a reverse clutch operably coupled to the planet carrier, the reverse clutch coaxial with the main axis.

6. The continuously variable transmission of claim 1, wherein the first clutch, the second clutch, the third clutch, and the fourth clutch are wet clutches.

7. The continuously variable transmission of claim 1, wherein the first clutch, the second clutch, the third clutch, and the fourth clutch are dry clutches.

8. The continuously variable transmission of claim 1, wherein the first clutch, the second clutch, the third clutch, and the fourth clutch are interfacing clutches.

9. The continuously variable transmission of claim 1, wherein the first clutch, the second clutch, the third clutch, and the fourth clutch are cone clutches.

10. The continuously variable transmission of claim 1, wherein engagement of the second clutch, engagement of the fourth clutch, disengagement of the first clutch, and disengagement of the third clutch corresponds to a second mode of operation.

11. The continuously variable transmission of claim 10, wherein the second mode of operation corresponds to an operating condition whereby an input torque is directed through two paths, a first path through the variator, and a second path through the planetary gear set.

12. The continuously variable transmission of claim 1, wherein engagement of the second clutch, engagement of the third clutch, disengagement of the first clutch, and disengagement of the fourth clutch corresponds to a third mode of operation.

13. The continuously variable transmission of claim 12, wherein the third mode of operation corresponds to an operating condition whereby an input torque is directed through two paths, a first path through the variator, and a second path through the planetary gear set.

14. The continuously variable transmission of claim 1, wherein engagement of the first clutch, disengagement of the second clutch, disengagement of the third clutch, and disengagement of the fourth clutch, corresponds to a first mode of operation,
wherein engagement of the second clutch, engagement of the fourth clutch, disengagement of the first clutch, and disengagement of the third clutch corresponds to a second mode of operation,
wherein engagement of the second clutch, engagement of the third clutch, disengagement of the first clutch, and disengagement of the fourth clutch corresponds to a third mode of operation, and
wherein the first mode of operation, the second mode of operation, and the third mode of operation correspond to different output speeds of the transmission.

15. The continuously variable transmission of claim 3, wherein the first mode of operation corresponds to the first traction ring assembly having substantially the same rotation speed as the first rotatable shaft.

16. A continuously variable transmission comprising:
a torque converter comprising a turbine, a pump, and a stator;
a first rotatable shaft aligned coaxially with the torque converter, the first rotatable shaft forming a main axis of the transmission;
a second rotatable shaft aligned coaxially with the first rotatable shaft, the second rotatable shaft coupled to the turbine;
a direct clutch coupled to the first rotatable shaft and a rotational source of power;
a variator assembly having a first traction ring assembly and a second traction ring assembly in contact with a plurality of traction planets, each traction planet having a tiltable axis of rotation;
wherein the variator assembly is coaxial with the main axis;
wherein the second traction ring assembly is operably coupled to the first rotatable shaft;
a planetary gearset having a ring gear, a carrier supporting a plurality of pinion gears, and a sun gear;
a one-way device operably coupled to the second rotatable shaft;
wherein the sun gear is coupled to the one-way device, and the carrier is operably coupled to the first traction ring assembly;
a first synchronizer assembly coupled to the carrier; and
a second synchronizer assembly coupled to the ring gear.

17. The continuously variable transmission of claim 16, wherein the first synchronizer mechanism is adapted to control the selective coupling of the ring gear to a housing and an output gear.

18. The continuously variable transmission of claim 17, wherein the second synchronizer mechanism is adapted to control the selective coupling of the carrier to the housing and the output gear.

19. A continuously variable transmission comprising:
a torque converter comprising a turbine, a pump, and a stator;
a first rotatable shaft aligned coaxially with the torque converter, the first rotatable shaft forming a main axis of the transmission;
a second rotatable shaft aligned coaxially with the first rotatable shaft, the second rotatable shaft coupled to the turbine;
a direct clutch coupled to the first rotatable shaft and a rotational source of power;
a variator assembly having a first traction ring assembly and a second traction ring assembly in contact with a plurality of traction planets, each traction planet having a tiltable axis of rotation;
wherein the variator assembly is coaxial with the main axis;
wherein the second traction ring assembly is operably coupled to the first rotatable shaft;
a planetary gearset having a ring gear, a carrier supporting a first plurality of pinion gears and a second plurality of pinion gears, and a sun gear;
a one-way device operably coupled to the carrier and the turbine;
wherein the sun gear is operably coupled to the first traction ring assembly;
a first clutch adapted to selectively couple the carrier to the sun gear; and
a second clutch adapted to selectively couple the ring gear to a grounded member.

20. A continuously variable transmission comprising:
a torque converter comprising a turbine, a pump, and a stator;
a first rotatable shaft aligned coaxially with the torque converter, the first rotatable shaft forming a main axis of the transmission;
a second rotatable shaft aligned coaxially with the first rotatable shaft, the second rotatable shaft coupled to the turbine;
a direct clutch coupled to the first rotatable shaft and a rotational source of power;
a variator assembly having a first traction ring assembly and a second traction ring assembly in contact with a plurality of traction planets, each traction planet having a tiltable axis of rotation;
wherein the variator assembly is coaxial with the main axis;
a planetary gearset having a ring gear, a carrier supporting a first plurality of pinion gears and a second plurality of pinion gears, and a sun gear;
wherein the second traction ring assembly is operably coupled to the sun gear;
a one-way device operably coupled to the carrier and the turbine;
wherein the first rotatable shaft is operably coupled to the first traction ring assembly;
a first clutch adapted to selectively couple the carrier to the sun gear; and
a second clutch adapted to selectively couple the ring gear to a grounded member.
